(19) United States
(12) Patent Application Publication
(10) Pub. No.: US 2008/0066169 A1
(43) Pub. Date: Mar. 13, 2008

(54) Fact Qualifiers in Security Scenarios

(75) Inventors: Blair B. Dillaway, Redmond, WA (US); Moritz Y. Becker, Cambridge (GB); Andrew D. Gordon, Cambridge (GB)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/530,433

(22) Filed: Sep. 8, 2006

(51) Int. Cl. H04L 9/32

(52) U.S. Cl. 726/9

(57) ABSTRACT

One or more fact qualifiers may be associated with an assertion in security scenarios. In an example implementation, each respective assertion may be associated with a respective fact qualifier in a security token having multiple assertions. In another example implementation, a fact qualifier of a first assertion may be checked or disregarded based on whether a corresponding second assertion includes a fact qualifier check constraint. In yet another example implementation, an assertion made by an assertor may be associated with multiple fact qualifiers.

### BACKGROUND

Computers and other electronic devices are pervasive in the professional and personal lives of people. In professional settings, people exchange and share confidential information during project collaborations. In personal settings, people engage in electronic commerce and the transmission of private information. In these and many other instances, electronic security is deemed to be important.

Electronic security paradigms can keep professional information confidential and personal information private. Electronic security paradigms may involve some level of encryption and/or protection against malware, such as viruses, worms, and spyware. Both encryption of information and protection from malware have historically received significant attention, especially in the last few years.

However, controlling access to information is an equally important aspect of securing the safety of electronic information. This is particularly true for scenarios in which benefits are derived from the sharing and/or transferring of electronic information. In such scenarios, certain people are to be granted access while others are to be excluded.

Access control has been a common feature of shared computers and application servers since the early time-shared systems. There are a number of different approaches that have been used to control access to information. They share a common foundation in combining authentication of the entity requesting access to some resource with a mechanism of authorizing the allowed access. Authentication mechanisms include passwords, Kerberos, and x.509 certificates. Their purpose is to allow a resource-controlling entity to positively identify the requesting entity or information about the entity that it requires.

Authorization examples include access control lists (ACLs) and policy-based mechanisms such as the eXtensible Access Control Markup Language (XACML) or the PrivilEge and Role Management Infrastructure (PERMIS). These mechanisms define what entities may access a given resource, such as files in a file system, hardware devices, database information, and so forth. They perform this authorization by providing a mapping between authenticated information about a requester and the allowed access to a resource.

As computer systems have become more universally connected over large networks such as the Internet, these mechanisms have proven to be somewhat limited and inflexible in dealing with evolving access control requirements. Systems of geographically dispersed users and computer resources, including those that span multiple administrative domains, in particular present a number of challenges that are poorly addressed by currently-deployed technology.

### SUMMARY

One or more fact qualifiers may be associated with an assertion in security scenarios. In an example implementation, each respective assertion may be associated with a respective fact qualifier in a security token having multiple assertions. In another example implementation, a fact qualifier of a first assertion may be checked or disregarded based on whether a corresponding second assertion includes a fact qualifier check constraint. In yet another example implementation, an assertion made by an assertor may be associated with multiple fact qualifiers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Moreover, other method, system, scheme, apparatus, device, media, procedure, API, arrangement, protocol, etc. implementations are described herein.

### BRIEF DESCRIPTION OF THE DRAWINGS

The same numbers are used throughout the drawings to reference like and/or corresponding aspects, features, and components.

FIG. 1 is a block diagram illustrating an example general environment in which an example security scheme may be implemented.

FIG. 2 is a block diagram illustrating an example security environment having two devices and a number of example security-related components.

FIG. 3 is a block diagram illustrating the example security environment of FIG. 2 in which example security-related data is exchanged among the security-related components.

FIG. 4 is a block diagram of an example device that may be used for security-related implementations as described herein.

FIG. 5 is a block diagram illustrating an example assertion format for a general security scheme.

FIG. 6 is a block diagram of an example security token including multiple respective assertions that are associated with multiple respective assertion fact qualifiers.

FIG. 7 is a block diagram of an example assertion that is associated with multiple assertion fact qualifiers.

FIG. 8 is a flow diagram that illustrates an example of a method for creating a security token having respective assertions that are associated with respective assertion fact qualifiers.

FIG. 9 is a block diagram illustrating an example token assertion format having a fact qualifier.

FIG. 10 is a block diagram illustrating an example policy assertion format having a fact qualifier checking constraint.

FIG. 11 is a flow diagram that illustrates an example of a method for empowering a relying party to determine if a fact qualifier is checked for conformance with a current environmental state.

### DETAILED DESCRIPTION

### Example Security Environments

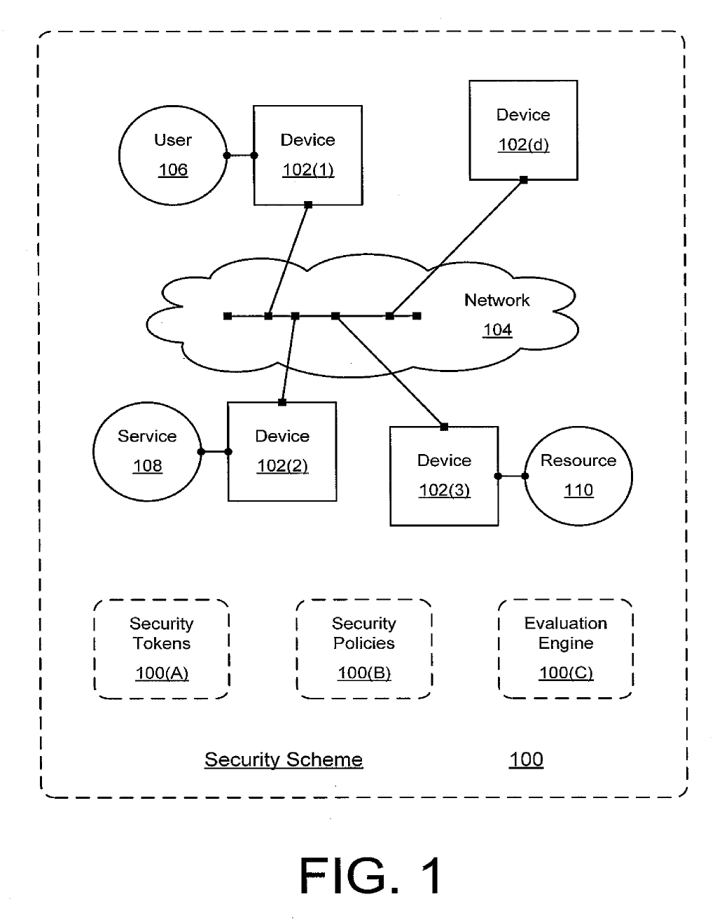

FIG. 1 is a block diagram illustrating an example general environment in which an example security scheme 100 may be implemented. Security scheme 100 represents an integrated approach to security. As illustrated, security scheme 100 includes a number of security concepts: security tokens 100(A), security policies 100(B), and an evaluation engine 100(C). Generally, security tokens 100(A) and security policies 100(B) jointly provide inputs to evaluation engine 100(C). Evaluation engine 100(C) accepts the inputs and produces an authorization output that indicates if access to some resource should be permitted or denied.

In a described implementation, security scheme 100 can be overlaid and/or integrated with one or more devices 102, which can be comprised of hardware, software, firmware, some combination thereof and so forth. As illustrated, “d” devices, with “d” being some integer, are interconnected over one or more networks 104. More specifically, device 102(1), device 102(2), device 102(3) . . . device 102(d) are capable of communicating over network 104.

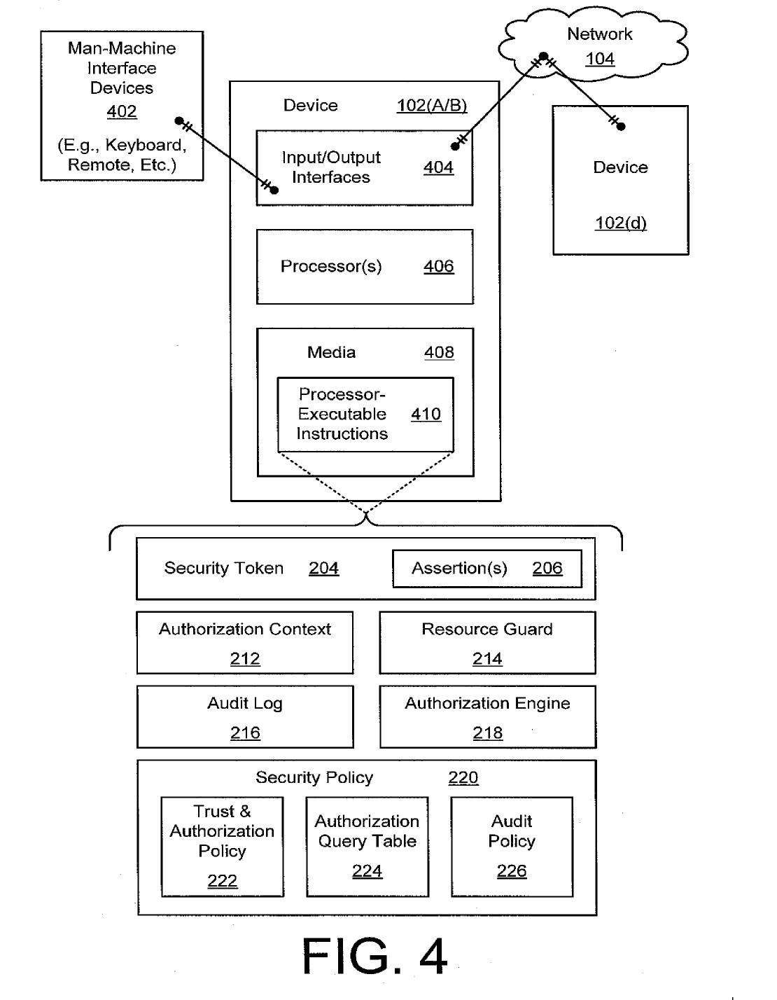

Each device 102 may be any device that is capable of implementing at least a part of security scheme 100. Examples of such devices include, but are not limited to, computers (e.g., a client computer, a server computer, a personal computer, a workstation, a desktop, a laptop, a palm-top, etc.), game machines (e.g., a console, a portable game device, etc.), set-top boxes, televisions, consumer electronics (e.g., DVD player/recorders, camcorders, digital video recorders (DVRs), etc.), personal digital assistants (PDAs), mobile phones, portable media players, some combination thereof, and so forth. An example electronic device is described herein below with particular reference to FIG. 4.

Network 104 may be formed from any one or more networks that are linked together and/or overlaid on top of each other. Examples of networks 104 include, but are not limited to, an internet, a telephone network, an Ethernet, a local area network (LAN), a wide area network (WAN), a cable network, a fibre network, a digital subscriber line (DSL) network, a cellular network, a Wi-Fie network, a WiMAX® network, a virtual private network (VPN), some combination thereof, and so forth. Network 104 may include multiple domains, one or more grid networks, and so forth. Each of these networks or combination of networks may be operating in accordance with any networking standard.

As illustrated, device 102(1) corresponds to a user 106 that is interacting with it. Device 102(2) corresponds to a service 108 that is executing on it. Device 102(3) is associated with a resource 110. Resource 110 may be part of device 102(3) or separate from device 102(3).

User 106, service 108, and a machine such as any given device 102 form a non-exhaustive list of example entities. Entities, from time to time, may wish to access resource 110. Security scheme 100 ensures that entities that are properly authenticated and authorized are permitted to access resource 110 while other entities are prevented from accessing resource 110.

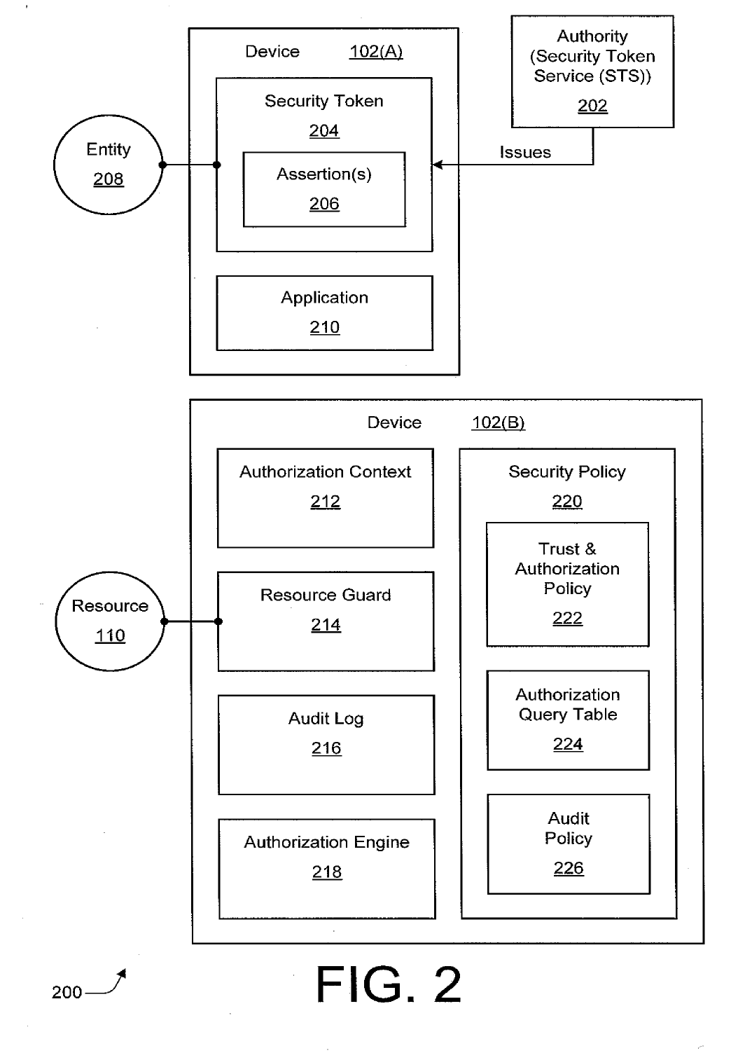

FIG. 2 is a block diagram illustrating an example security environment 200 having two devices 102(A) and 102(B) and a number of example security-related components. Security environment 200 also includes an authority 202, such as a security token service (STS) authority. Device 102(A) corresponds to an entity 208. Device 102(B) is associated with resource 110. Although a security scheme 100 may be implemented in more complex environments, this relatively-simple two-device security environment 200 is used to describe example security-related components.

As illustrated, device 102(A) includes two security-related components: a security token 204 and an application 210. Security token 204 includes one or more assertions 206. Device 102(B) includes five security-related components: an authorization context 212, a resource guard 214, an audit log 216, an authorization engine 218, and a security policy 220. Security policy 220 includes a trust and authorization policy 222, an authorization query table 224, and an audit policy 226.

Each device 102 may be configured differently and still be capable of implementing all or a part of security scheme 100. For example, device 102(A) may have multiple security tokens 204 and/or applications 210. As another example, device 102(B) may not include an audit log 216 or an audit policy 226. Other configurations are also possible.

In a described implementation, authority 202 issues security token 204 having assertions 206 to entity 208. Assertions 206 are described herein below, including in the section entitled “Security Policy Assertion Language Example Characteristics”. Entity 208 is therefore associated with security token 204. In operation, entity 208 wishes to use application 210 to access resource 110 by virtue of security token 204.

Resource guard 214 receives requests to access resource 110 and effectively manages the authentication and authorization process with the other security-related components of device 102(B). Trust and authorization policy 222, as its name implies, includes policies directed to trusting entities and authorizing actions within security environment 200. Trust and authorization policy 222 may include, for example, security policy assertions (not explicitly shown in FIG. 2). Authorization query table 224 maps requested actions, such as access requests, to an appropriate authorization query. Audit policy 226 delineates audit responsibilities and audit tasks related to implementing security scheme 100 in security environment 200.

Authorization context 212 collects assertions 206 from security token 204, which is/are used to authenticate the requesting entity, and security policy assertions from trust and authorization policy 222. These collected assertions in authorization context 212 form an assertion context. Hence, authorization context 212 may include other information in addition to the various assertions.

The assertion context from authorization context 212 and an authorization query from authorization query table 224 are provided to authorization engine 218. Using the assertion context and the authorization query, authorization engine 218 makes an authorization decision. Resource guard 214 responds to the access request based on the authorization decision. Audit log 216 contains audit information such as, for example, identification of the requested resource 110 and/or the algorithmic evaluation logic performed by authorization engine 218.

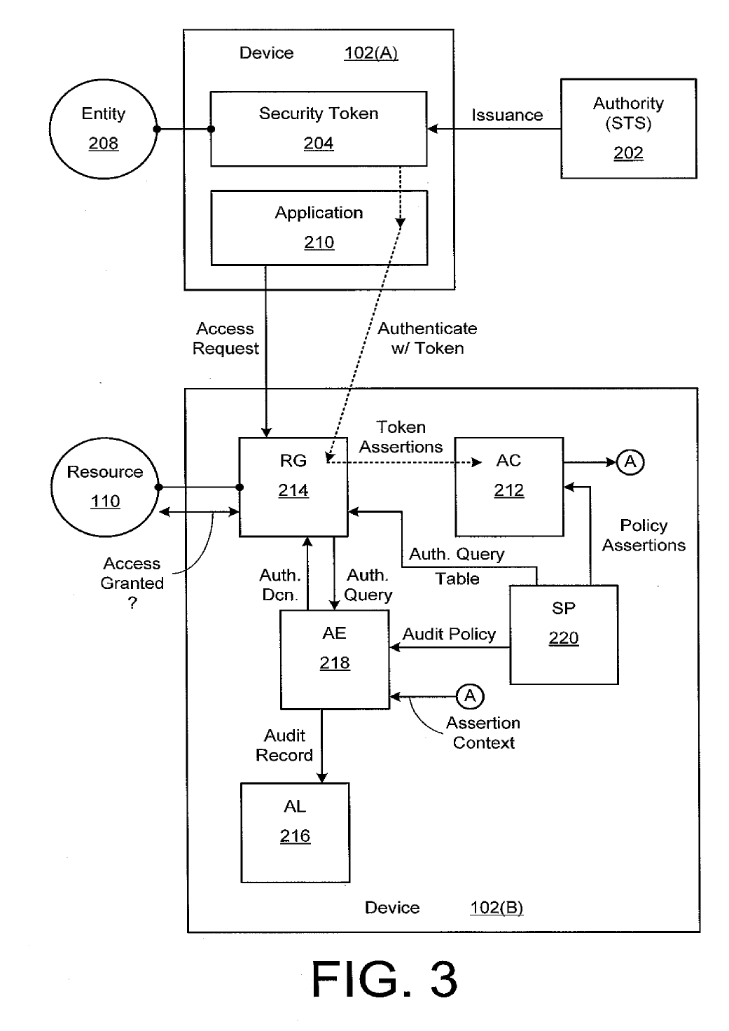

FIG. 3 is a block diagram illustrating example security environment 200 in which example security-related data is exchanged among the security-related components. The security-related data is exchanged in support of an example access request operation. In this example access request operation, entity 208 wishes to access resource 110 using application 210 and indicates its authorization to do so with security token 204. Hence, application 210 sends an access request* to resource guard 214. In this description of FIG. 3, an asterisk (i.e., “*”) indicates that the stated security-related data is explicitly indicated in FIG. 3.

In a described implementation, entity 208 authenticates* itself to resource guard 214 with a token*, security token 204. Resource guard 214 forwards the token assertions* to authorization context 212. These token assertions are assertions 206 (of FIG. 2) of security token 204. Security policy 220 provides the authorization query table* to resource guard 214. The authorization query table derives from authorization query table module 224. The authorization query table sent to resource guard 214 may be confined to the portion or portions directly related to the current access request.

Policy assertions are extracted from trust and authorization policy 222 by security policy 220. The policy assertions may include both trust-related assertions and authorization-related assertions. Security policy 220 forwards the policy assertions* to authorization context 212. Authorization context 212 combines the token assertions and the policy assertions into an assertion context. The assertion context* is provided from authorization context 212 to authorization engine 218 as indicated by the encircled “A”.

An authorization query is ascertained from the authorization query table. Resource guard 214 provides the authorization query (auth. query*) to authorization engine 218. Authorization engine 218 uses the authorization query and the assertion context in an evaluation algorithm to produce an authorization decision. The authorization decision (auth. dcn.*) is returned to resource guard 214. Whether entity 208 is granted access* to resource 110 by resource guard 214 is dependent on the authorization decision. If the authorization decision is affirmative, then access is granted. If, on the other hand, the authorization decision issued by authorization engine 218 is negative, then resource guard 214 does not grant entity 208 access to resource 110.

The authorization process can also be audited using semantics that are complementary to the authorization process. The auditing may entail monitoring of the authorization process and/or the storage of any intermediate and/or final products of, e.g., the evaluation algorithm logically performed by authorization engine 218. To that end, security policy 220 provides to authorization engine 218 an audit policy* from audit policy 226. At least when auditing is requested, an audit record* having audit information may be forwarded from authorization engine 218 to audit log 216. Alternatively, audit information may be routed to audit log 216 via resource guard 214, for example, as part of the authorization decision or separately.

FIG. 4 is a block diagram of an example device 102 that may be used for security-related implementations as described herein. Multiple devices 102 are capable of communicating across one or more networks 104. As illustrated, two devices 102(A/B) and 102(d) are capable of engaging in communication exchanges via network 104. Although two devices 102 are specifically shown, one or more than two devices 102 may be employed, depending on the implementation.

Generally, a device 102 may represent any computer or processing-capable device, such as a client or server device; a workstation or other general computer device; a PDA; a mobile phone; a gaming platform; an entertainment device; one of the devices listed above with reference to FIG. 1; some combination thereof; and so forth. As illustrated, device 102 includes one or more input/output (I/O) interfaces 404, at least one processor 406, and one or more media 408. Media 408 include processor-executable instructions 410.

In a described implementation of device 102, 1/0 interfaces 404 may include (i) a network interface for communicating across network 104, (ii) a display device interface for displaying information on a display screen, (iii) one or more man-machine interfaces, and so forth. Examples of (i) network interfaces include a network card, a modem, one or more ports, and so forth. Examples of (ii) display device interfaces include a graphics driver, a graphics card, a hardware or software driver for a screen or monitor, and so forth. Printing device interfaces may similarly be included as part of I/O interfaces 404. Examples of (iii) man-machine interfaces include those that communicate by wire or wirelessly to man-machine interface devices 402 (e.g., a keyboard, a remote, a mouse or other graphical pointing device, etc.).

Generally, processor 406 is capable of executing, performing, and/or otherwise effectuating processor-executable instructions, such as processor-executable instructions 410. Media 408 is comprised of one or more processor-accessible media. In other words, media 408 may include processor-executable instructions 410 that are executable by processor 406 to effectuate the performance of functions by device 102.

Thus, realizations for security-related implementations may be described in the general context of processor-executable instructions. Generally, processor-executable instructions include routines, programs, applications, coding, modules, protocols, objects, components, metadata and definitions thereof, data structures, application programming interfaces (APIs), schema, etc. that perform and/or enable particular tasks and/or implement particular abstract data types. Processor-executable instructions may be located in separate storage media, executed by different processors, and/or propagated over or extant on various transmission media.

Processor(s) 406 may be implemented using any applicable processing-capable technology. Media 408 may be any available media that is included as part of and/or accessible by device 102. It includes volatile and non-volatile media, removable and non-removable media, and storage and transmission media (e.g., wireless or wired communication channels). For example, media 408 may include an array of disks/flash memory/optical media for longer-term mass storage of processor-executable instructions 410, random access memory (RAM) for shorter-term storing of instructions that are currently being executed, link(s) on network 104 for transmitting communications (e.g., security-related data), and so forth.

As specifically illustrated, media 408 comprises at least processor-executable instructions 410. Generally, processor-executable instructions 410, when executed by processor 406, enable device 102 to perform the various functions described herein, including those actions that are illustrated in the various flow diagrams. By way of example only, processor-executable instructions 410 may include a security token 204, at least one of its assertions 206, an authorization context module 212, a resource guard 214, an audit log 216, an authorization engine 218, a security policy 220 (e.g., a trust and authorization policy 222, an authorization query table 224, and/or an audit policy 226, etc.), some combination thereof, and so forth. Although not explicitly shown in FIG. 4, processor-executable instructions 410 may also include an application 210 and/or a resource 110.

### Security Policy Assertion Language Example Characteristics

This section describes example characteristics of an implementation of a security policy assertion language (SecPAL). The SecPAL implementation of this section is described in a relatively informal manner and by way of example only. It has an ability to address a wide spectrum of security policy and security token obligations involved in creating an end-to-end solution. These security policy and security token obligations include, by way of example but not limitation: describing explicit trust relationships; expressing security token issuance policies; providing security tokens containing identities, attributes, capabilities, and/or delegation policies; expressing resource authorization and delegation policies; and so forth.

In a described implementation, SecPAL is a declarative, logic-based language for expressing security in a flexible and tractable manner. It can be comprehensive, and it can provide a uniform mechanism for expressing trust relationships, authorization policies, delegation policies, identity and attribute assertions, capability assertions, revocations, audit requirements, and so forth. This uniformity provides tangible benefits in terms of making the security scheme understandable and analyzable. The uniform mechanism also improves security assurance by allowing one to avoid, or at least significantly curtail, the need for semantic translation and reconciliation between disparate security technologies.

A SecPAL implementation may include any of the following example features: [1] SecPAL can be relatively easy to understand. It may use a definitional syntax that allows its assertions to be read as English-language sentences. Also, its grammar may be restrictive such that it requires users to understand only a few subject-verb-object (e.g., subject-verb phrase) constructs with cleanly defined semantics. Finally, the algorithm for evaluating the deducible facts based on a collection of assertions may rely on a small number of relatively simple rules.

[2] SecPAL can leverage industry standard infrastructure in its implementation to ease its adoption and integration into existing systems. For example, an extensible markup language (XML) syntax may be used that is a straightforward mapping from the formal model. This enables use of standard parsers and syntactic correctness validation tools. It also allows use of the W3C XML Digital Signature and Encryption standards for integrity, proof of origin, and confidentiality.

[3] SecPAL may enable distributed policy management by supporting distributed policy authoring and composition. This allows flexible adaptation to different operational models governing where policies, or portions of policies, are authored based on assigned administrative duties. Use of standard approaches to digitally signing and encrypting policy objects allow for their secure distribution. [4] SecPAL enables an efficient and safe evaluation. Simple syntactic checks on the inputs are sufficient to ensure evaluations will terminate and produce correct answers.

[5] SecPAL can provide a complete solution for access control requirements supporting required policies, authorization decisions, auditing, and a public-key infrastructure (PKI) for identity management. In contrast, most other approaches only manage to focus on and address one subset of the spectrum of security issues. [6] SecPAL may be sufficiently expressive for a number of purposes, including, but not limited to, handling the security issues for Grid environments and other types of distributed systems. Extensibility is enabled in ways that maintain the language semantics and evaluation properties while allowing adaptation to the needs of specific systems.

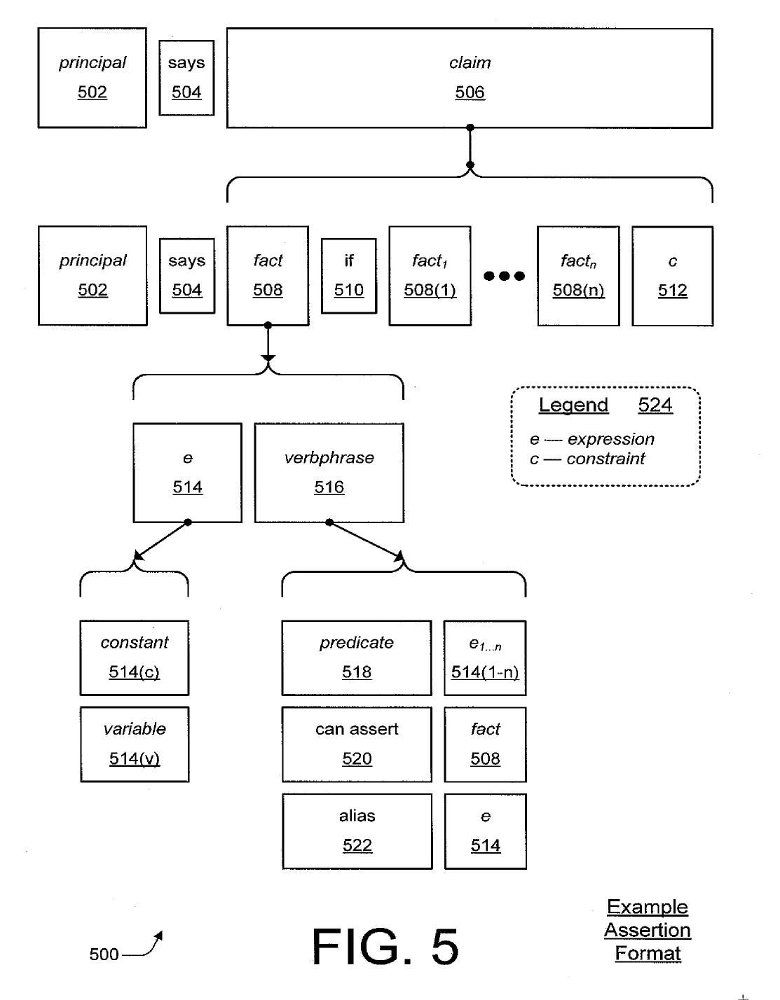

FIG. 5 is a block diagram illustrating an example assertion format 500 for a general security scheme. Security scheme assertions that are used in the implementations described otherwise herein may differ from example assertion format 500. However, assertion format 500 is a basic illustration of one example format for security scheme assertions, and it provides a basis for understanding example described implementation of various aspects of a general security scheme.

As illustrated at the top row of assertion format 500, an example assertion at a broad level includes: a principal portion 502, a says portion 504, and a claim portion 506. Textually, the broad level of assertion format 500 may be represented by: principal says claim.

At the next row of assertion format 500, claim portion 506 is separated into example constituent parts. Hence, an example claim portion 506 includes: a fact portion 508, an if portion 510, “n” conditional fact_{1 . . . n} portions 508(1 . . . n), and a c portion 512. The subscript “n” represents some integer value. As indicated by legend 524, c portion 512 represents a constraint portion. Although only a single constraint is illustrated, c portion 512 may actually represent multiple constraints (e.g., c₁, . . . , cₘ). The set of conditional fact portions 508(1 . . . n) and constraints 512(1 . . . m) on the right-hand side of if portion 510 may be termed the antecedent.

Textually, claim portion 506 may be represented by: fact if fact₁, . . . , factₙ, c. Hence, the overall assertion format 500 may be represented textually as follows: principal says fact if fact₁, . . . , factₙ, c. However, an assertion may be as simple as: principal says fact. In this abbreviated, three-part version of an assertion, the conditional portion that starts with if portion 510 and extends to c portion 512 is omitted.

Each fact portion 508 may also be further subdivided into its constituent parts. Example constituent parts are: an e portion 514 and a verb phrase portion 516. As indicated by legend 524, e portion 514 represents an expression portion. Textually, a fact portion 508 may be represented by: e verbphrase.

Each e or expression portion 514 may take on one of two example options. These two example expression options are: a constant 514(c) and a variable 514(v). Principals may fall under constants 514(c) and/or variables 514(v).

Each verb phrase portion 516 may also take on one of three example options. These three example verb phrase options are: a predicate portion 518 followed by one or more e_{1 . . . n} portions 514(1 . . . n), a can assert portion 520 followed by a fact portion 508, and an alias portion 522 followed by an expression portion 514. Textually, these three verb phrase options may be represented by: predicate e₁ . . . eₙ, can assert fact, and alias e, respectively. The integer “n” may take different values for facts 508(1 . . . n) and expressions 514(1 . . . n).

Generally, SecPAL statements are in the form of assertions made by a security principal. Security principals are typically identified by cryptographic keys so that they can be authenticated across system boundaries. In their simplest form, an assertion states that the principal believes a fact is valid (e.g., as represented by a claim 506 that includes a fact portion 508). They may also state a fact is valid if one or more other facts are valid and some set of conditions are satisfied (e.g., as represented by a claim 506 that extends from a fact portion 508 to an if portion 510 to conditional fact portions 508(1 . . . n) to a c portion 512). There may also be conditional facts 508(1 . . . n) without any constraints 512 and/or constraints 512 without any conditional facts 508(1 . . . n).

In a described implementation, facts are statements about a principal. Four example types of fact statements are described here in this section. First, a fact can state that a principal has the right to exercise an action(s) on a resource with an “action verb”. Example action verbs include, but are not limited to, call, send, read, list, execute, write, modify, append, delete, install, own, and so forth. Resources may be identified by universal resource indicators (URIs) or any other approach.

Second, a fact can express the binding between a principal identifier and one or more attribute(s) using the “possess” verb. Example attributes include, but are not limited to, email name, common name, group name, role title, account name, domain name server/service (DNS) name, internet protocol (IP) address, device name, application name, organization name, service name, account identification/identifier (ID), and so forth. An example third type of fact is that two principal identifiers can be defined to represent the same principal using the “alias” verb.

“Qualifiers” or fact qualifiers may be included as part of any of the above three fact types. Qualifiers enable an assertor to indicate environmental parameters (e.g., time, principal location, etc.) that it believes should hold if the fact is to be considered valid. Such statements may be cleanly separated between the assertor and a relying party's validity checks based on these qualifier values.

An example fourth type of fact is defined by the “can assert” verb. This “can assert” verb provides a flexible and powerful mechanism for expressing trust relationships and delegations. For example, it allows one principal (A) to state its willingness to believe certain types of facts asserted by a second principal (B). For instance, given the assertions “A says B can assert fact0” and “B says fact0”, it can be concluded that A believes fact0 to be valid and therefore it can be deduced that “A says fact0”.

Such trust and delegation assertions may be (i) unbounded and transitive to permit downstream delegation or (ii) bounded to preclude downstream delegation. Although qualifiers can be applied to “can assert” type facts, omitting support for qualifiers to these “can assert” type facts can significantly simplify the semantics and evaluation safety properties of a given security scheme.

In a described implementation, concrete facts can be stated, or policy expressions may be written using variables. The variables are typed and may either be unrestricted (e.g., allowed to match any concrete value of the correct type) or restricted (e.g., required to match a subset of concrete values based on a specified pattern).

Security authorization decisions are based on an evaluation algorithm (e.g., that may be conducted at authorization engine 218) of an authorization query against a collection of assertions (e.g., an assertion context) from applicable security policies (e.g., a security policy 220) and security tokens (e.g., one or more security tokens 204). Authorization queries are logical expressions, which may become quite complex, that combine facts and/or conditions. These logical expressions may include, for example, AND, OR, and/or NOT logical operations on facts, either with or without attendant conditions and/or constraints.

This approach to authorization queries provides a flexible mechanism for defining what must be known and valid before a given action is authorized. Query templates (e.g., from authorization query table 224) form a part of the overall security scheme and allow the appropriate authorization query to be declaratively stated for different types of access requests and other operations/actions.

### Example Implementations for Fact Qualifiers in Security Scenarios

When making security decisions, especially in distributed systems, environmental factors are often important to consider. These include things such as: the time an access is being made; the location of the entity requesting access; the availability of revocation information at the site making the security decision; the presence of specific physical resources (e.g., disk space, printer availability, etc.). Effective use of such information entails two things. First, the authority making a security assertion is capable of encoding information about the environment it believes the assertion should be used within. Second, the entity relying on that information should be able to independently decide whether or not it wishes to enforce such environmental restrictions and/or impose additional environmental restrictions when granting access.

Conventional approaches provide very limited mechanisms for considering environmental factors. For example, existing security tokens such as Kerberos, x.509, and REL only define mechanisms for encoding validity dates for an entire token. Other types of potential environmental factors are generally ignored. Moreover, conventional approaches do not provide support for policy writers to explicitly encode if, when, where, how, and/or to what extent the policy writers may wish to consider environmental factors when deciding whether or not to rely on an assertion.

In contrast, certain implementations as described herein enable the encoding of one or more of a multitude of potential environmental parameters. These environmental parameters may be encoded in association with individual assertions as fact qualifiers. In addition to time limitations, fact qualifiers may also reflect a desired location restriction, connectivity mechanism restriction, and so forth. Furthermore, policy assertions may be written such that a relying party is empowered (i) to explicitly require the checking of a fact qualifier or (ii) to explicitly disregard any fact qualifier originally placed on an assertion.

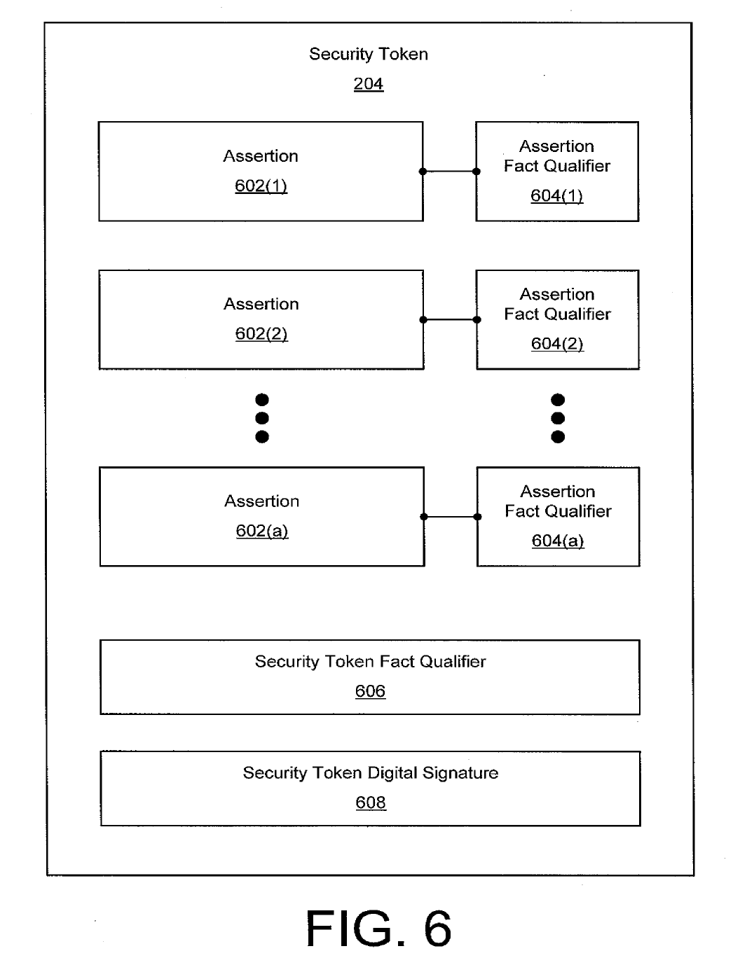

FIG. 6 is a block diagram of an example security token 204 including multiple respective assertions 602 that are associated with multiple respective assertion fact qualifiers 604. As illustrated, security token 204 includes “a” assertions 602, with “a” being some integer. Each respective assertion 602(x) is associated with a respective assertion fact qualifier 604(x). Hence, there are “a” assertion fact qualifiers 604 illustrated in FIG. 6. Security token 204 also includes a security token fact qualifier 606 and a security token digital signature 608.

In a described implementation, each assertion 602 is associated with at least one assertion fact qualifier 604. An assertion fact qualifier 604 may be integrated with its associated assertion 602, may be coupled to its associated assertion 602, or otherwise associated with its assertion 602. Specifically, assertion 602(1) is associated with assertion fact qualifier 604(1), assertion 602(2) is associated with assertion fact qualifier 604(2), . . . , assertion 602(a) is associated with assertion fact qualifier 604(a).

As is described further herein below, an assertion fact qualifier 604 enables its associated assertion 602 to be independently qualified with regard to at least one environmental parameter separately from the remaining assertions 602 of a given security token 204. As is also described herein below, security token fact qualifier 606, if present, enables the entire security token 204 (including all assertions 602 thereof) to be impacted by a single fact qualifier or a single set of fact qualifiers. In other words, when included as part of security token 204, the fact qualifier of security token fact qualifier 606 can be used to place environmental restrictions on all assertions 602 of security token 204.

Security token digital signature 608, if present, is a digital signature for security token 204. Thus, security token digital signature 608 may be considered a single digital signature across all assertions 602 of security token 204. Alternatively, a single digital signature may cover or be applied across multiple, but not all, assertions 602 of a given security token 204. Security token digital signature 608 serves to provide authentication and/or integrity confirmation for data that it has signed.

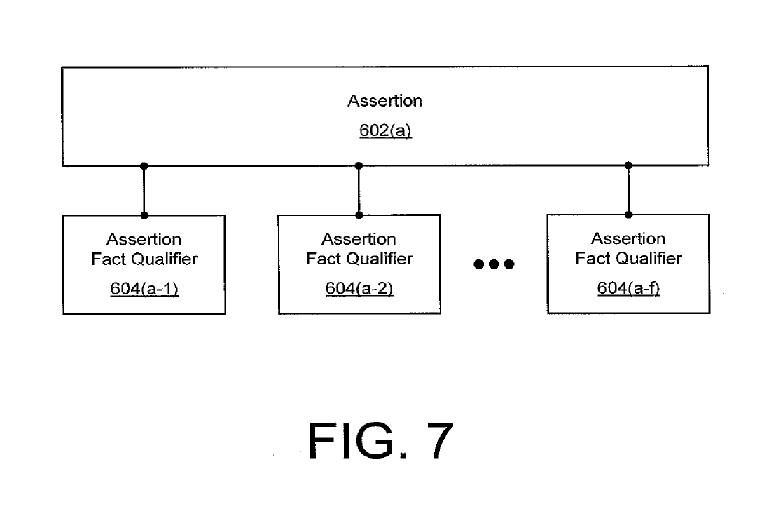

FIG. 7 is a block diagram of an example assertion 602(a) that is associated with multiple assertion fact qualifiers 604(a). As illustrated, assertion 602(a) is associated with “f” assertion fact qualifiers 604(a), with “F” being some integer greater than one in this implementation having multiple assertion fact qualifiers 604(a) for assertion 602(a). Assertion 602(a) is thus associated with assertion fact qualifier 604(a-1), assertion fact qualifier 604(a-2), . . . , assertion fact qualifier 604(a-f). Each assertion fact qualifier 604(a-x) may also be considered a different environmental parameter of assertion fact qualifier 604(a).

In a described implementation, having multiple assertion fact qualifiers 604 being associated with a single assertion 602 provides additional environmental restriction options. For example, assertion fact qualifier 604(a-1) may relate to a temporal environmental restriction, and assertion fact qualifier 604(a-2) may relate to a location environmental restriction. In this example, the assertor of assertion 602(a) can therefore indicate two different types of environmental parameters that it believes should hold for the remainder of the assertion to be considered valid.

In these manners, environmental restrictions may be enabled and applied at the granularity of individual assertions 602 of a security token 204. Additional explanations and examples are provided below.

In a described implementation, a fine-grained fact qualifier semantic that operates at the granularity of an individual security assertion is defined. It should be understood that fact qualifiers in security scenarios as described herein is generally applicable to assertions that adhere to any given format. However, by way of example only, the assertion format described in the preceding section is used to illuminate certain aspects of fact qualifiers as described herein.

Thus, as described above, an example general form of a security assertion is: principal says claim, where claim may be a fact or a conditioned fact (e.g., fact if fact₁, fact₂, . . . , factₙ, c₁, c₂, . . . cₘ). In the examples that follow, principal is sometimes represented generically by A for assertor.

From a fact qualifying perspective, such an example assertion may therefore be represented by: A says fact, fact qualifier (excluding the optional conditional part of if fact_{1 . . . n} c_{1 . . . m}). In this sense, the associated fact qualifier instituting an environmental parameter may be part of the asserted fact. More generally, an example assertion format may be represented by: A says fact, fact qualifier₁fact qualifier₂ . . . fact qualifier_{f}. (or, more succinctly, A says fact, fact qualifier_{1 . . . f}). This latter format further indicates that a single assertion 602(a) may be associated with multiple assertion fact qualifiers 604(a-1 . . . f).

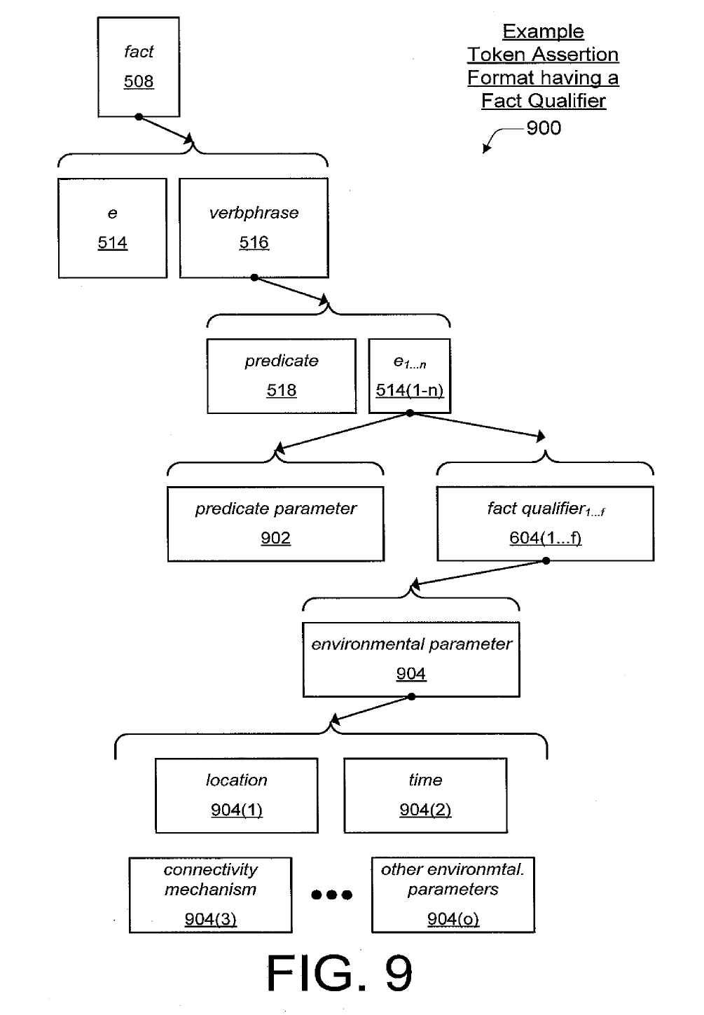

A relying party, such as an author of a security policy, is empowered to selectively elect whether or not a fact qualifier of an assertion will be checked and/or enforced. This is described further herein below, particularly with reference to FIGS. 9-11.

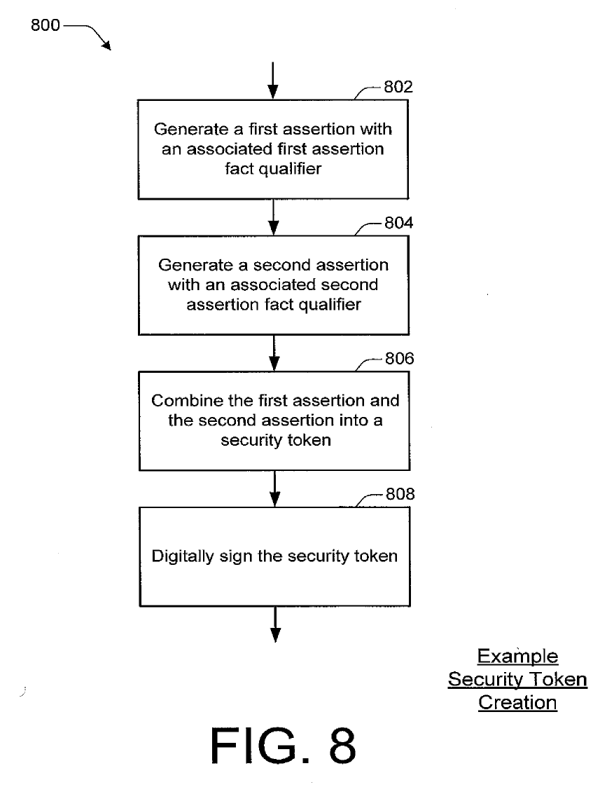

FIG. 8 is a flow diagram 800 that illustrates an example of a method for creating a security token having respective assertions that are associated with respective assertion fact qualifiers. Flow diagram 800 includes four (4) blocks 802-808. Although the actions of flow diagram 800 may be performed in other environments and with a variety of hardware/software/firmware combinations, some of the features, components, and aspects of FIGS. 1-7 are used to illustrate an example of the method. For example, an entity 208, a device 102(A), and/or an STS authority 202 may jointly implement the actions of flow diagram 800.

In a described implementation, at block 802, a first assertion with an associated first assertion fact qualifier is generated. For example, assertion 602(1) that is associated with assertion fact qualifier 604(1) may be generated by an asserter.

At block 804, a second assertion with an associated second assertion fact qualifier is generated. For example, assertion 602(2) that is associated with assertion fact qualifier 604(2) may be generated by the asserter.

At block 806, the first assertion and the second assertion are combined into a security token. For example, assertion 602(1) and assertion 602(2) may be combined into security token 204. The combining action(s) may be performed at device 102(A) and/or at STS authority 202.

At block 808, the security token is digitally signed. For example, security token digital signature 608 may be created and applied to security token 204 by STS authority 202. The digital signature of security token digital signature 608 serves to cover (e.g., to authenticate and possibly to guarantee integrity for) both assertion 602(1) and assertion 602(2). The digital signature may also serve to sign other assertions 602 and/or other parts of security token 204, including up to the entirety of the security-related data of security token 204.

Thus, in a described implementation, there is a general mechanism (i) for expressing environmental restrictions that an assertor wishes to associate with assertions it makes and (ii) for enabling a relying party to selectively check those environmental restrictions.

A general purpose mechanism is described for associating any number of environmental parameters with a security assertion. This enables the assertor to explicitly encode its intent regarding if, when, how, etc. the assertion should be relied upon. As indicated above, each set of environmental parameters is termed a fact qualifier.

Environmental parameters include, by way of example but not limitation, the following: (1) A validity time span—It may be represented as a date-time tuple [t1, t2]. It indicates that the assertor intended this assertion to be used only during the interval defined by the two endpoints of the date-time tuple.

(2) Location—It may be expressed as one or more locations from which a request requiring evaluation of the associated assertion should be made. There are many ways such a location may be encoded. Examples include, but are not limited to, a machine Domain Name Server/Service (DNS) name, an IP network address, latitude/longitude coordinates, and so forth. Any location-specifying approach may be utilized as long as the relying party has a mechanism available to determine the origin of a resource request.

(3) Revocation freshness check—It may be encoded as a duration relative to the evaluation time within which a check of associated revocation information should be made.

(4) Connectivity mechanism—It may be expressed as a term describing the mechanism of connection for a resource requestor Examples include, but are not limited to, a private wired LAN, the internet, a public Wi-Fi hot spot, a virtual private network (VPN), and so forth.

As indicated above, fact qualifiers may be encoded as zero or more parameters within an asserted fact. The general form of an asserted fact (ignoring the optional conditional part) is: A says principal predicate parameters. The parameters may be logically separated into those that are associated with the predicate and those that are fact qualifiers, which gives: A says principal predicate predicate-parameters fact-qualifiers. This logical separation is illustrated in FIG. 9, which is described herein below.

It should be noted that, at least in certain implementations as described herein, fact qualifiers are not written as conditional validity expressions on the asserted fact. In other words, they are not included as part of the logical antecedent. Allowing an assertion-specific environmental parameter to be encoded as a conditional validity expression allows the asserting authority to establish the acceptance policy at the location where the assertion is used as part of an access control decision. This violates a fundamental security tenant, which is that the relying party should control what is acceptable to it.

Hence, it is the relying party that is preferably in ultimate control over whether or not it wishes to enforce environmental restrictions (e.g., a time span restriction, a location restriction, a revocation information freshness restriction, etc.) that the assertor believes should be considered and checked to determine if they hold. Certain implementations as described herein, especially those described further below, separate the beliefs of the assertor from those of the relying party. Moreover, these implementations allow the relying party to explicitly be in control over whether or not it checks conformance to any suggested environmental restrictions based on the declarative policy the relying party establishes.

In a described implementation, fact qualifiers in security scenarios may be realized with a security language. Such a security language enables fact qualifiers such as environmental restrictions to be expressed declaratively as part of an assertion by an assertor or issuer of the assertion. The language also enables relying parties to utilize the same approach when determining whether or not they require that the declared environmental parameters be checked with conformance to a current environmental state (i.e., whether they are to be checked to see if they hold). More specifically, the relying party may author a security policy assertion that includes the fact qualifier as a constraint (if the environmental parameter is to be checked) or author a security policy assertion that does not include such a fact qualifier checking constraint (if the environmental parameter need not be checked to determine if it holds).

FIG. 9 is a block diagram illustrating an example token assertion format 900 having a fact qualifier 604. Token assertion format 900 derives from assertion format 500 (of FIG. 5). As shown in FIG. 5, fact portion 508 is part of claim portion 506. Claim portion 506 also includes if portion 510 and the antecedent that follows, which is fact_{1 . . . n} portions 501(1 . . . n) and constraint_{1 . . . m} portions 512(1 . . . m). Thus, fact portion 508 is not a portion of the conditional or antecedent part of assertion format 500. This is described in greater detail herein above with reference to FIG. 5 in the section entitled “Security Policy Assertion Language Example Characteristics”.

As illustrated in FIG. 9, fact portion 508 includes an expression portion 514 and a verb phrase portion 516. Verb phrase portion 516 includes a predicate portion 518 and one or more expression_{1 . . . n} portions 514(1 . . . n). As described above, expressions 514(1 . . . n) may be logically segmented into one or more predicate parameters 902 and one or more fact qualifiers_{1 . . . f} 604(1 . . . f). By way of example, predicate parameters 902 may be a file name (if predicate 518 is “can read”), an attribute (if predicate 518 is “possesses”), and so forth.

In a described implementation, each fact 508 may actually include zero or more fact qualifiers 604. In example token assertion format 900, fact 508 includes at least one fact qualifier 604. Fact qualifiers may be any restriction that an assertor believes should hold for fact 508 to be considered valid. An example fact qualifier type is the environmental parameter 904.

There are many different types of environmental parameters 904 that may be relevant to a given assertion in a security scenario. Example environmental parameters 904 include, by way of example but not limitation, location 904(1), time 904(2), connectivity mechanism 904(3) . . . other environmental parameters 904(o). For instance, an assertor may wish for an assertion to be valid if a resource requestor is making a resource request through a local wired network owned by a company and for the assertion not to be valid if the request is transmitted over a public wireless network. This can be encoded using a connectivity mechanism 904(3) option for environmental parameter 904 of fact qualifier 604.

Assertions are a general declarative statement in an example implementation of a security language as described herein. They may be conceptually separated into categories, for example, such as token assertions and policy assertions. Token assertions are those assertions presented in support of a resource-related request. Policy assertions are those assertions prepared by an administrator or other policy author to form part of a security policy specifying the requirements for accessing a given resource. Token assertions may be part of a security token 204, and policy assertions may be part of a trust and authorization policy 222 (both of FIG. 2).

However, these two categorizations and the explanations thereof are examples only. Others may be added, and these may be defined differently. Moreover, they are conceptual categorizations. Generally, any kind of assertion may be handled in the same manner regardless of its source or categorization. For example, both token and policy assertions may be combined into an assertion context as part of authorization context 212. They are then addressed similarly or even identically by authorization engine 218. Consequently, although assertions are categorized as being token assertions or policy assertions in the descriptions of FIGS. 9-11, such categorization is by way of facilitating the explanation and not by way of limitation.

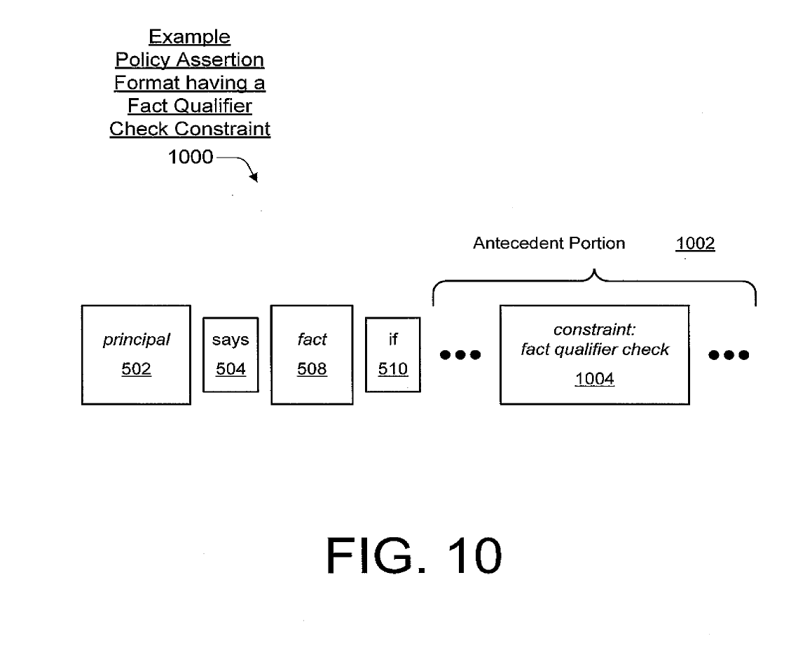

FIG. 10 is a block diagram illustrating an example policy assertion format 1000 having fact qualifier checking constraint 1004. As illustrated, policy assertion format 1000 includes a principal portion 502, a says portion 504, a fact portion 508, an if portion 510, and an antecedent portion 1002. With reference to FIG. 5, antecedent portion 1002 may include one or more conditional facts_{1 . . . n} 508(1 . . . n) and/or one or more constraints,m 512(1 . . . m). As illustrated in FIG. 10, antecedent portion 1002 includes at least one constraint 512 that comprises a fact qualifier check, which is termed herein a fact qualifier check constraint 1004.

In a described implementation, if a relying party wishes to ensure that a conformance check for a given fact qualifier is performed, a fact qualifier check constraint 1004 is included as part of the conditional antecedent portion 1002. On the other hand, if the relying party wishes to analyze an assertion regardless of the current environmental state, fact qualifier check constraint 1004 is omitted from antecedent portion 1002. In this manner, the language enables the relying party, such as a security policy author or administrator type, to decide whether or not a fact qualifier is checked for conformance to a current environmental state (i.e., to decide whether or not a fact qualifier is checked to determine if it holds).

Example assertion 900 (of FIG. 9) is an assertion that corresponds to example assertion 1000. Hence, when fact qualifier check constraint 1004 is present in assertion 1000, the relying party does perform a conformance check on fact qualifier 604 of assertion 900. On the other hand, when fact qualifier check constraint 1004 is not present in assertion 1000, the relying party elects not to perform a conformance check on fact qualifier 604 of assertion 900. Consequently, in this latter situation, the remainder of assertion 900 is treated as if fact qualifier 604 is determined to hold.

Three example token assertion and corresponding policy assertion pairs are provided below. For a first example, a token assertion having a fact qualifier is given as:
A says C can read foo [T1, T2],
   with the fact qualifier being “[T1, T2]”. A corresponding policy assertion that includes a fact qualifier check constraint is:
B says A can assert x can read foo [t1, t2] if t1<curr. time<t2,
   with the fact qualifier check constraint being “t1<curr. time<t2”. And a corresponding policy assertion that does not include a fact qualifier check constraint is:
B says A can assert x can read foo [t1, t2].

### Hence, the relying party checks the fact qualifier with the former policy assertion but not with the latter one.

For a second example, there is a policy assertion that explicitly checks the fact qualifier constraint in the context of the first token assertion above. The corresponding policy assertion is given as:
A says x can read bar if x can read foo [t1], t2], t1<curr. time<t2.
   When combined with the first token assertion above, this authorizes C to read bar only if the current time is in the interval [T1, T2]. And a corresponding policy assertion that does not include a fact qualifier check constraint is:
A says x can read bar if x can read foo [t1, t2].

### Hence, the relying party checks the fact qualifier with the former policy assertion but not with the latter one.

For a third example, a token assertion having a fact qualifier is given as:
B says C can read foo [T1, T2] [Location=ms.com],
   with the two fact qualifiers being “[T1, T2]” and “[Loc=ms.com]”. A corresponding policy assertion that includes a fact qualifier check constraint is:
B says x can write bar if x can read foo [t1], t2] [loc], t2-t1<8 hours and Request-Location-In(loc),
   with the fact qualifier check constraints being “t2-t1<8 hours” and “Request-Location-In(loc)”. The latter constraint checks that the actual location from which the request associated with the evaluation was made is in the “ms.com” DNS domain. And a corresponding policy assertion that does not include a fact qualifier check constraint is:
B says x can write bar if x can read foo [t1, t2] [loc].
   Hence, the relying party checks the fact qualifier with the former policy assertion but not with the latter one. In general, the relying party or author of the policy assertions may add, delete, change, etc. the fact qualifier check constraints at any time as the attendant security situation evolves.

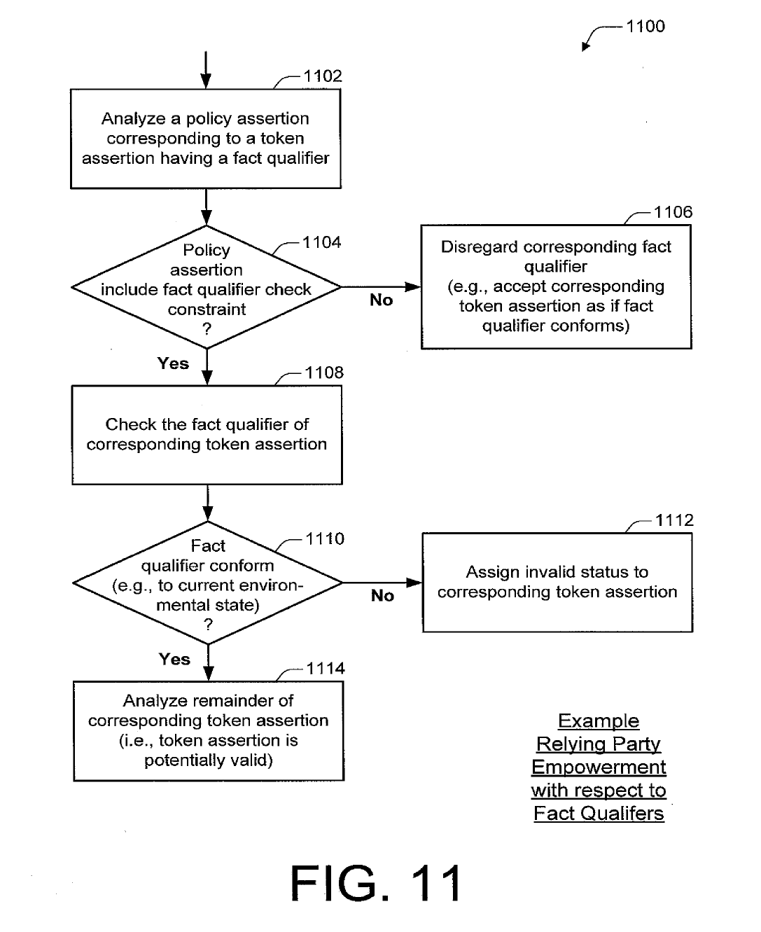

FIG. 11 is a flow diagram 1100 that illustrates an example of a method for empowering a relying party to determine if a fact qualifier is checked for conformance with a current environmental state. Flow diagram 1100 includes seven (7) blocks 1102-1114. Although the actions of flow diagram 1100 may be performed in other environments and with a variety of hardware/software/firmware combinations, some of the features, components, and aspects of FIGS. 1-10 are used to illustrate an example of the method. For example, a resource guard 214, a device 102(B), a security policy 220, and/or an authorization engine 218 may jointly implement the actions of flow diagram 1100.

In a described implementation, at block 1102, a policy assertion that corresponds to a token assertion having a fact qualifier is analyzed. For example, a policy assertion 1000, which corresponds to a token assertion 900 having a fact qualifier 604, may be analyzed.

At block 1104, it is determined if the policy assertion includes a fact qualifier check constraint. For example, it may be determined if policy assertion 1000 includes a fact qualifier check constraint 1004. If not, then at block 1106, the corresponding fact qualifier may be disregarded. Hence, the corresponding token assertion may be accepted as if the fact qualifier holds (e.g., as if it is determined to be conforming). For example, fact qualifier 604 may be disregarded, and token assertion 900 may be accepted for further authorization engine processing.

If, on the other hand, the policy assertion is determined (at block 1104) to include a fact qualifier check constraint, then at block 1108 the fact qualifier of the corresponding token assertion is checked. For example, fact qualifier 604 of token assertion 900 can be checked to determine if it conforms. More specifically, at block 1110 it is determined if the fact qualifier conforms to a current environmental state. For example, it may be determined if one or more environmental parameters 904 conform to a current environmental state as ascertained by the relying party.

If the fact qualifier does not conform, then at block 1112 an invalid status is assigned to the corresponding token assertion. For example, token assertion 900 may be labeled as invalid and processed within authorization engine 21 8 accordingly. If, on the other hand, the fact qualifier is determined (at block 1110) to conform to the current environmental state, then at block 1114 the remainder of the corresponding token assertion is analyzed. In other words, because the corresponding token assertion is potentially valid (e.g., it is not rendered invalid by its fact qualifier), its processing may continue within authorization engine 218.

The devices, actions, aspects, features, functions, procedures, modules, data structures, protocols, components, etc. of FIGS. 1-11 are illustrated in diagrams that are divided into multiple blocks. However, the order, interconnections, interrelationships, layout, etc. in which FIGS. 1-11 are described and/or shown are not intended to be construed as a limitation, and any number of the blocks can be modified, combined, rearranged, augmented, omitted, etc. in any manner to implement one or more systems, methods, devices, procedures, media, apparatuses, APIs, protocols, arrangements, etc. for fact qualifiers in security scenarios.

Although systems, media, devices, methods, procedures, apparatuses, mechanisms, schemes, approaches, processes, arrangements, and other implementations have been described in language specific to structural, logical, algorithmic, and functional features and/or diagrams, it is to be understood that the invention defined in the appended claims is not necessarily limited to the specific features or acts described above. Rather, the specific features and acts described above are disclosed as example forms of implementing the claims.

What is claimed is:

1. One or more processor-accessible media comprising processor-executable instructions that include a security token, the security token comprising multiple respective assertions that are associated with multiple respective assertion fact qualifiers; wherein each individual assertion of the multiple respective assertions may be independently checked for conformance with a current environmental state using a particular assertion fact qualifier that is associated with the individual assertion.

2. The one or more processor-accessible media as recited in claim 1, wherein at least one assertion of the multiple assertions is associated with more than one assertion fact qualifier.

3. The one or more processor-accessible media as recited in claim 1, wherein the security token flier comprises a digital signature that signs the multiple assertions.

4. The one or more processor-accessible media as recited in claim 15 wherein the particular assertion fact qualifier includes an environmental parameter pertaining to at least one of time, location, connectivity mechanism, or a revocation freshness check.

5. The one or more processor-accessible media as recited in claim 1, wherein the individual assertion is a security assertion having a logical form comprising:
Assertor says fact, fact qualifier_{1 . . . f},
where “f” represents some integer greater than zero.

6. The one or more processor-accessible media as recited in claim 1, wherein the individual assertion comprises at least a fact portion and an antecedent portion; and wherein the particular assertion fact qualifier is part of the fact portion but not part of the antecedent portion.

7. A method for determining if a fact qualifier of a first assertion is to be checked based on a corresponding second assertion, the method comprising:
determining if the second assertion includes a fact qualifier check constraint;
if the second assertion is not determined to include a fact qualifier check constraint, disregarding the fact qualifier of the first assertion; and
if the second assertion is determined to include a fact qualifier check constraint, checking the fact qualifier of the first assertion.

8. The method as recited in claim 7, wherein the first assertion comprises a token assertion that is part of a security token; and wherein the second assertion comprises a policy assertion that is part of a trust and authorization policy.

9. The method as recited in claim 7, wherein the disregarding the fact qualifier of the first assertion comprises processing the first assertion as if the fact qualifier holds.

10. The method as recited in claim 7, wherein the checking the fact qualifier of the first assertion comprises determining if the fact qualifier of the first assertion conforms to a current environmental state.

11. The method as recited in claim 10, further comprising:
if the fact qualifier of the first assertion is determined to conform to the current environmental state, continuing to process the first assertion; and
if the fact qualifier of the first assertion is not determined to conform to the current environmental state, assigning an invalid status to the first assertion.

12. The method as recited in claim 7, wherein the second assertion is a security assertion having a logical form comprising:
principal says fact if fact₁, . . . , factₙ, constraint₁, . . . , constraintₘ,
where “n” and “m” represent integers greater than or equal to zero; and wherein the determining determines if a fact qualifier check constraint exists as part of the constraint_{1 . . . m} portion of the second assertion.

13. A system comprising a security scheme that enables an assertion made by an assertor to be associated with multiple fact qualifiers, wherein each fact qualifier indicates at least one environmental parameter that the assertor believes should hold for the associated assertion to be considered valid.

14. The system as recited in claim 13, wherein the security scheme permits general environmental parameters in addition to time to be specified by each fact qualifier.

15. The system as recited in claim 14, wherein the general environmental parameters in addition to time that may be specified include location of a using principal connectivity mechanism of the using principal, and freshness of a most recent revocation check by a potential relying party.

16. The system as recited in claim 13, wherein the security scheme further enables creation of a security token having multiple assertions that are each individually associated wit at least one respective fact qualifier, the security token having a digital signature that signs the multiple assertions.

17. The system as recited in claim 13, wherein the system comprises a first device and a second device, the second device associated with a resource; and wherein the security scheme implements a security assertion language that enables a first user of the first device to access the resource of the second device based on, at least in part, the assertion that is associated with multiple fact qualifiers.

18. The system as recited in claim 17, wherein a second user of the second device is empowered by the security assertion language to selectively check each fact qualifier of the multiple fact qualifiers for conformance with a current environmental state and to decide to process the assertion regardless of whether any particular fact qualifier is checked.

19. The system as recited in claim 18, wherein the second user is empowered by the security assertion language because the security assertion language enables policy assertions to include constraints that stipulate whether or not a fact qualifier check in to be performed.

20. The system as recited in claim 13, wherein the security scheme enables a party that may rely on the assertion to affirmatively constrain which fact qualifiers of the multiple fact qualifiers, if any, are to be checked before potentially considering the assertion valid.
